(19) United States
(12) Patent Application Publication
(10) Pub. No.: US 2012/0115115 A1
(43) Pub. Date: May 10, 2012

(54) Contingency Management Behavioral Change Therapy with Virtual Assets and Social Reinforcement as Incentive-Rewards

(75) Inventor: Darion Rapoza, Durham, NC (US)

(73) Assignee: Darion Rapoza, Durham, NC (US)

(21) Appl. No.: 13/276,314

(22) Filed: Oct. 18, 2011

Related U.S. Application Data
(60) Provisional application No. 61/394,122, filed on Oct. 18, 2010.

(51) Int. Cl. G09B 19/00

(52) U.S. Cl. 434/236

(57) ABSTRACT

A method for behavior change therapy based on contingency management, using virtual assets from interactive digital environments as incentive-rewards. The invention teaches rewarding positive behavior changes with reinforcement (or the delivery of incentive-rewards) in the form of virtual goods, virtual services, virtual currency, virtual abilities, and social reinforcement in various contexts including videogames and virtual environments.

### CROSS-REFERENCE TO RELATED APPLICATION

This application claims benefit of Provisional Application No. 61/394,122 filed Oct. 18, 2010, the entire disclosure of which is hereby incorporated by reference herein for all purposes.

### FIELD OF THE INVENTION

The invention relates to the field of human behavioral modification using contingency management.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Contingency management is a behavioral modification procedure for increasing (or decreasing) the frequency with which a subject engages in a target behavior. It comprises the steps of 1) monitoring the target behavior, and 2) rewarding the subject contingent with the delivery of an incentive-reward upon their having engaged in (or not having engaged in, respectively) the said target behavior during the preceding monitoring period, as indicated by the monitoring procedure. A typical example is a contingency management program for substance use disorder rehabilitation. Drug screening, such as by urine testing, is performed on a schedule to monitor the subjects' drug use. Subjects then receive incentive-rewards such as cash payment or vouchers that may be exchanged for items of value in return for producing drug-free urine samples. Contingency management, which consists of delivering incentives (typically money) contingent on objective evidence of smoking abstinence (e.g., carbon monoxide [CO]), is among the most effective interventions for helping people initiate abstinence⁴⁻⁶.

Significant drawbacks of this approach include the expense of providing the incentive-rewards, and failure to use this effective procedure more often due to cultural objections to use of a procedure that pays people for doing (or not doing) what they should be doing (or not be doing, respectively) to improve their own health and well-being. For example, although the costs associated with providing monetary incentives contingent on smoking abstinence are likely to be less than the costs associated with medical complications caused by smoking[1], the cost of incentives is often cited as a barrier to contingency management[2, 3]. Sustainability of contingency management programs is made more difficult because the longer it has been since the participant has changed, having adopted the target behavior, the less willing they or other payers become to continue to bear the expense of providing incentive-rewards. Cost limits both the feasibility and long-term sustainability of contingency management. For over a decade, investigators have attempted to identify alternate approaches for incentive-reward delivery in contingency management to improve feasibility and sustainability of the contingency management method, yet feasibility and sustainability remain significant concerns. Examples of these alternate approaches include lottery-based incentive-rewards; incentive-rewards that are personal favors contingently provided by significant others per individualized contracts; and deposit contracts. Lottery-based incentive rewards offer participants a probabilistic chance at actually receiving an incentive-reward for meeting a milestone, thereby reducing program costs as fewer incentive-rewards need to actually be delivered. Unfortunately, increasing the uncertainty that an incentive reward will be received if a milestone is met decreases the effectiveness of contingency management. Individualized contracts with personalized incentive-rewards delivered by significant others (e.g., a home improvement project, a significant romantic interlude) can be effective, but take significant effort to set up and maintain, particularly over time, and thus often do not represent an actual cost savings, and could have unintended or undesirable side-effects on personal relationships. Although deposit contracts—a method in which an initial monetary deposit can be recouped on the basis of successful behavioral change, such as extended abstinence from alcohol, tobacco, or other drug use—can be a cost-effective alternative to reducing program costs, the deposit requirement simply shifts the financial burden to the participant, and may be a barrier to participation for some [4].

### Individualized Contingency Management

A large and growing number of studies indicate that contingent reinforcement of smoking abstinence can exert powerful control over smoking [5-18]. In these studies, reinforcement was contingent on specified reductions in breath carbon monoxide (CO). Corby et al. [19] found that over 90% of the CO samples were negative during treatment in a small group of adolescents, and Dallery et al. [8] found that 65% of the CO samples were negative during treatment in a sample of heavy smokers. An obstacle in applying abstinence reinforcement therapy to smokers is measuring CO on a daily basis for a sustained period. Because breath CO has a half-life of about 6-8 hours [6, 20], samples should be collected at least twice per day to accurately measure smoking status [21]. Requiring clinic visits or making home visit to collect CO samples represents a high response effort, and such visits on a daily basis would not be feasible in most cases due to distance, transportation, disability, clinic hours, and other practical reasons [8]. Moreover, such an in-person model would unnecessarily restrict the accessibility and dissemination potential of the treatment. Effective behavioral treatments for smoking should be more accessible to target populations; indeed, the “access gap” can be so reduced substantially through Internet based methods [22].

Dallery and colleagues have developed an innovative, effective, Internet-based voucher reinforcement program to promote smoking cessation [7, 8, 23]. Smoking status is verified by employing user-friendly Internet technology to observe participants providing CO samples via a web camera. The Internet-based system obviates many of the logistical problems entailed by frequent CO monitoring and produces high rates of abstinence even in high risk and underserved communities. For example, Reynolds, Dallery, et al. [24] used the intervention to reduce smoking in adolescent smokers, and Stoops, Dallery et al. [25] successfully applied the Internet-based program to smokers in the rural Appalachian region of Kentucky. An Internet based-program directly addresses some of the major limitations (access, cost, dissemination potential) inherent in traditional abstinence reinforcement delivery models.

### Group Contingency Management

Group contingencies can be more effective than individual contingencies at producing desirable behavior change among a variety of target behaviors (to reduce disruptive behavior: [[26-31]; to reduce stealing: [32]; to reduce cash shortages in a small business [33], to increase creativity among elementary school students [34], to increase the verbalizations of severely retarded residents [35], and to reduce substance use in cocaine-dependent individuals [36]. Under group contingencies, a common consequence depends on the behavior of one or more members of the group [37]. A so-called interdependent group contingency is arranged when consequences (e.g., voucher reinforcers) are delivered to each member of a group only if all members of the group meet a specified criterion. There are two straightforward variations of the interdependent contingency—one in which all incentive-rewards depend on group behavior (a full group contingency), and one in which only some depend on group behavior (a mixed group contingency). It is not known which method is more useful in promoting cessation. There are reasons to believe that either one of these arrangements may produce greater effectiveness and/or acceptability. For example, because of the greater stringency of the full group contingency, participants may rate it as less acceptable and opt not to participate. However, this more stringent feature may no also produce greater effects as they may place increased social pressure on each individual to meet the contingencies. These two arrangements are also supported by research as being effective configurations (see [37] for a review), and there is at least one report that suggests mixed contingencies may produce greater effects [38].

Multiplayer online videogame-based group contingency management is ideally-suited to engage social contingencies and promote dramatic behavior change such as smoking cessation. Much of online gameplay already occurs in self-organizing social groups that work together towards accomplishing a common game objective. Frequently, games are designed to include certain objectives that can only be achieved through cooperative group play. Unlike individual contingencies of reinforcement, group contingencies create an environment in which social consequences are more likely to promote desirable behavior [37]. Under group contingencies, group members have been found to cooperate, encourage, and support one another's performance [27, 39]. Participants in group contingency management report that they are indeed influenced by their peers [40], and such contingencies have been found to increase cooperation in children working toward a common goal [39].

Virtual Goods are defined as non-physical, digital representations of objects purchased for use in online communities and online games. They have no intrinsic value outside the artificial “digital environment” for and in which they are created, and are intangible by definition[41]. Including digital gifts[42] and digital clothing for avatars[43], virtual goods may also alternatively be classified as services instead of goods and are usually sold by companies that operate social networks, community sites, or online games[41]. Sales of virtual goods are sometimes referred to as microtransactions[44], and the games that utilize this model are usually referred to as freemium (free+premium) games. In 2009, games played on social networks such as Facebook, games that primarily derive revenue from the sale of virtual goods, brought in 1 billion USD, and that is expected to increase to 1.6 billion in 2010[45]. Worldwide, 7.3 billion USD was made from virtual goods that same year[46]. These figures confirm that gaining access to virtual goods and services can have powerful reinforcing properties that can be expressed in terms of monetary value.

In economics, Rivalry and Excludability are characteristics of a good. A rival good is a good whose consumption by one consumer prevents simultaneous consumption by other consumers. Put differently, a good is considered non-rival if, for any level of production, the cost of providing it to a marginal (additional) individual is zero. A good or service is said to be Excludable when it is possible to prevent people who have not paid for it from having access to it, and Non-Excludable when it is not possible to do so. Virtual Goods can be instantiated by software at virtually no cost and access to them can be completely controlled, and are therefore Non-Rival, Excludable goods. Furthermore, it has been demonstrated that they can have significant economic/monetary value.

### BRIEF SUMMARY OF THE INVENTION

The invention is a method for behavior modification which uses virtual assets and prompted social reinforcement in interactive digital environments, such as videogames and virtual worlds, as incentive-rewards in contingency management procedures.

The objective of the invention is to enhance the feasibility and sustainability of the Contingency Management approach to behavior change therapy.

The invention significantly differs from current practice in contingency management therapy for behavioral modification such as smoking cessation and drug or alcohol rehabilitation research and clinical practice. Current research and practice are largely based on intrusive approaches in which the target audience is imposed upon to make room in their daily schedules to participate in the intervention activities. In contrast, the use of interactive digital environments such as videogames and virtual worlds will leverage the principle that “the more central the delivery context is to the target audience's existing life routines, the more likely the intervention and associated research will be able to recruit and retain members of the target population” [47] by embodying the intervention as a highly desirable, normative leisure-time activity (such as videogame play) of a type in which the target audience already engages and for which it sets aside time for on a regular (and in many cases, daily) basis. While contingency management approaches [48] and videogames have been around since at least 1994, and multiple research studies have sought to improve the feasibility and sustainability of contingency management by using alternatives to monetary incentive-rewards, attempts to use interactive digital environment based virtual assets and social reinforcement as incentive-rewards in contingency management programs has not been reported in the scientific literature to date[49]. As it is possible to create virtual assets that can only be used by the participant that earned them, the invention obviates concerns that the incentive-rewards being employed, for instance, to support abstinence from drug use might be diverted by the participant for use to purchase more drugs, as might occur where monetary or even voucher-based incentive rewards are used. Thus, the invention enhances the feasibility of the contingency management approach for certain applications. Furthermore the invention enhances the sustainability of the contingency management approach, both by the fact that the incentive-rewards can be instantiated ad infinitum at virtually no-cost, and by the fact that the method can be applied in a plurality of interactive digital environments over time (e.g., in multiple videogames, such that the participant can remain in contingency management therapy as they tire of one game and move on to another). Employing virtual assets and social reinforcement as Incentive-Rewards in Contingency Management programs is thus expected to meet the objective of the invention to enhance the feasibility and sustainability of the Contingency Management approach to behavior change therapy.

### BRIEF DESCRIPTION OF THE SEVERAL VIEWS OF THE DRAWING

Not applicable.

### DETAILED DESCRIPTION OF THE PREFERRED EMBODIMENT OF THE INVENTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Although the preferred embodiment described falls within the field of smoking cessation, it is intended to be understood that the method described could also be applied behavior modification in general, examples including but not limited to: reduction and/or cessation of any alcohol, tobacco, or other drug use; improved compliance with any health behavior protocol, e.g., self-monitoring blood glucose and complying with treatments for diabetes; compliance with asthma treatment regimens; or promotion of any desirable behavior or reduction or elimination of any undesirable behavior. Although the embodiment described is for an online multiplayer game played over the Internet, the invention includes virtual worlds; videogames; computer games; simulations; and social network game applications where the application is used on a local area network isolated from the Internet, or a Wide Area Network Isolated from the Internet, or a Virtual Private Network; as well as single-player versions of the application similar to multi-user online version of the application, but comprising only those features that are also applicable to a single participant application.

The invention is a method for behavior modification which uses virtual assets and prompted social reinforcement in interactive digital environments as incentive-rewards in contingency management procedures, where:

Behavior Modification means intentionally increasing or intentionally decreasing the probability that an individual will engage in the specific behavior or behavioral pattern targeted by the Behavioral Modification procedure. Examples of potential Behavioral Modification objectives include but are not limited to: smoking cessation; reduction of or abstention from use of alcohol or other drugs; and increasing compliance with drug treatment or other therapeutic regimens.

Virtual Asset means a virtual good, virtual service, virtual currency, virtual skill or virtual attribute that may either or both 1) be used in trade for or as a resource, upgrade or power-up, or key that may be used to unlock some feature or area within a game, simulation, or virtual world, that would otherwise be unobtainable, take time and effort to obtain through in-game achievements, or is scarce and available only in limited supply; 2) may have intrinsic value to the participant (but no programmed supplemental functional value) when deployed within a game, simulation, or virtual world, such as an appealing or personalized graphic that the participant can display, or a graphical indication of a real-world accomplishment, such as a “3 Months Smoke-Free” badge.

Prompted Social Reinforcement means that when a target participant achieves a behavior modification milestone, other participants are prompted by the software to provide social reinforcement to the target participant for their accomplishment. Examples include, but are not limited to: (a) other participants are cued to provide the target participant with social reinforcement in the form of chat messages (e.g., “player X has been smoke-free for 2 weeks today, click <Here> to tell them “Congratulations!), (b) other participants are provided with “gifts” they can only use to give to the target participant as an incentive-reward (which the target participant can then use directly); and (c) other participants are provided with earmarked, augmentable gifts that they can enhance before giving the gift to the target participant. Augmenting the gift takes “work” in the interactive digital environment or costs real or virtual currency to buy, but the player doing the augmenting receives no direct benefit for augmenting the gift. Thus, the recipient of an augmented gift will know that another player has performed work or expended resources for the privilege of giving them a gift to congratulate them for meeting their latest goal (designed to enhance the value of the social reinforcer). Augmentable gifts are commonly used in online social strategy games.

Interactive Digital Environment means a computer generated and computer controlled environment and its contents, portrayed to the user through any of plurality of display devices designed to stimulate the human senses (visual, auditory, tactile, olfactory, or taste), where the state or behavior of the said environment and its contents can be changed by users' actions according to a set of rules, as communicated via the user's input through the use of any of a plurality of input devices. The term Interactive Digital Environment includes but is not limited to: Virtual Worlds; Videogames; Computer Games; Simulations; and Social Network Games.

Virtual World means a computer simulation of an environment in which representations of the users can be present at and move to various locations from which the users may perceive and interact with the environment. The users may be represented by avatars. An avatar may be used to “travel” through locations of the virtual world, such as virtual streets, buildings, rooms, etc. While in a given location, an avatar may also be used to interact with virtual elements (i.e., objects or other avatars) present therein. For example, an avatar may be able to approach another avatar, and may interact with the other avatar by communicating, performing a financial transactions, and the like. Thus, multiple users, although in different physical locations, may be present in the same virtual location, and may interact therein by using their respective avatars.

Videogame means a game that employs electronics to create an interactive system which a player can interact with via a user interface to generate visual feedback on a video device. For many videogames, the game action is set within a Virtual World.

Computer Game means a game played on a computer.

Game means an activity (termed “play” or “gameplay”), governed by a set of rules, which is undertaken for the purpose of having fun by one or more participants (termed “players”) who interact with and manipulate elements of the game as they strive to meet the challenge of reaching or completing “the objective(s) of the game,” where said objective(s) exist only as game construct(s), the attainment of which has no intrinsic value outside the artificial environment of the game beyond the expected gratification of successfully completing the game activity itself. Games, which by definition meet all the aforementioned criteria, may also incorporate simulations, training exercises, educational material, educational exercises for learning, practice, and review, behavioral change procedures, and a plurality of other methods designed to improve real-world knowledge, skills, attitudes, and behaviors. Games that do so are game hybrids (e.g., educational games, training games, behavior change games, etc.,). However, if the primary objective of the user is not “to have fun,” or completing the objective of the activity has intrinsic value outside the construct of the activity (e.g., mastering a simulation), the activity is not a game, but some other type of exercise (e.g., educational exercise, training simulation, behavioral change program, etc.).

Simulation means the imitation of some real thing available, or some real or potentially real (e.g., hypothetical) state of affairs or process. The act of simulating something generally entails representing certain key characteristics or behaviors of a selected physical or abstract system.

Social Network Game means a multiplayer, online game that is played through social networks, and typically features asynchronous gameplay mechanics, which allow rules to be resolved without needing players to play at the same time. Social network games are most often implemented as browser games, but can also be implemented on other platforms such as smartphones and other mobile devices. Social network games leverage the player's social graph and individual user data that is hosted on the social network, such as by using social networks to recruit game allies; linking game rewards, access to quests, and the ability to achieve various game objectives to the number of friends (connected via the social network hosting the game) the player has “shared” the game with, or the number of friends from their social network the player has [recruited to play the game] as game allies; and linking social media activity and influence to game rewards. Social network games may use “virtual currency”, which players usually must purchase with real-world money. With the in-game currency players can buy upgrades that would otherwise take much longer to earn through in-game achievements. In many cases, some upgrades are only available via the virtual currency. To optimize the likelihood of ongoing play and continued socializing and social networking within the game, Social Networking Games may have no victory conditions. In other words, the game never ends and no one is ever declared “winner”. Instead, many casual games have “quests” or “missions” for players to complete.

Incentive-Reward means an asset that an individual will voluntarily exert deliberate effort to obtain and that is being used to motivate an individual's behavior. More precisely, an asset is an Incentive when promised in return for specified future performance, a Reward when contingently delivered as promised in return for having performed as specified, and in either case may generally be referred to as an Incentive-Reward.

Contingency Management means a process comprising the steps of (1) objective verification of compliance with the behavioral objectives of the Behavior Modification procedure (e.g., diagnostic biomeasures of correlates of smoking or drug use, such as monitoring CO levels in the breath, cotinine levels in saliva, or various drug and drug metabolite levels in the blood or urine). (2) Contingent delivery of incentive-rewards upon meeting compliance milestones (e.g., milestones for a smoking cessation program might include various intervals of continuous abstinence from smoking).

In the preferred embodiment, cigarette smoking is the behavior selected for modification, smoking cessation is the objective of the behavioral modification procedure, and the embodiment of the Interactive Digital Environment is an online, persistent world multiplayer videogame that participants are expected to play approximately 1-5 hours per week at their convenience. Throughout the procedure participant's smoking is objectively assessed twice a day by monitoring CO levels in the exhaled breath. Participants may perform the Internet enabled monitoring procedure from the comfort of their own home via a computer with a web-camera and Internet access. In-game virtual assets and prompted social reinforcement are employed as incentive-rewards. The preferred embodiment has four phases: Baseline, during which CO levels are monitored, and participants start playing the game; Tapering, during which participants can earn incentive-rewards for decreasing their smoking; Cessation, during which participants can only earn incentive-rewards for abstinence from smoking; and Thinning, during which participants can still earn incentive-rewards, but the monitoring frequency is gradually decreased. A schedule of compliance milestones is set and incentive-rewards are contingently delivered immediately upon verification of participants' having met each one (e.g., milestones for smoking cessation can include various intervals of continuous abstinence from smoking). In the preferred embodiment, Incentive-Rewards may be delivered both as the consequence of satisfying individual contingencies (the participant meets a milestone) and of satisfying group contingencies (players are assigned to groups, and [1] every member of a group must meet a milestone for all members of the group to receive given individual incentive-rewards, or for all members of the group to receive access to a single group reward (e.g., access to a new game level); or [2] As each member of a group meets a given milestone, all members of the group receive a new incentive-reward, and are informed which participant enabled them to receive it).

In the preferred embodiment of the game, participants assume the role of a character that is a smoker. The game simulates the potential real-world consequences of smoking and likely consequences of quitting smoking in the game by portraying them as occurring to the participant's character. The achievement of a plurality of game objectives is facilitated by or dependent upon the participant getting their character to quit smoking. In the preferred embodiment of the game, one's game character abstains from smoking or relapses to smoking in parallel with the participant's real-life smoking status as assessed by the monitoring procedure. In one alternative embodiment, one's character can achieve abstinence through a combination of in-game choices and/or accomplishments and real-world abstinence.

1) I claim a method for behavior modification which uses virtual assets and/or prompted social reinforcement in interactive digital environments as incentive-rewards in contingency management procedures comprising the steps of:
a. Selecting a target behavior to be modified.
b. Providing access to an interactive digital environment in which one or more of the virtual assets will be made available.
c. Setting the schedule of behavioral change objectives to be applied over the time course of the behavior modification therapy (i.e., setting behavioral compliance milestones).
d. Monitoring the target behavior in a manner that objectively verifies a participant's compliance with the behavioral objectives of the Behavior Modification procedure.
e. Setting a schedule of incentive-reward contingencies that establishes what incentive-rewards are available for the accomplishment of each behavioral compliance milestone.
f. Delivering virtual assets to the participants as incentive-rewards contingent upon their meeting behavioral compliance milestones as assessed by said monitoring procedure.

2) The method for behavior modification of claim (1) wherein said interactive digital environment is a videogame, computer game, or social network game.

3) The method for behavior modification of claim (2) wherein said virtual assets are limited to those virtual assets that have intrinsic value to the participant but no programmed utility, functionality or impact on the game when deployed therein.

4) The method for behavior modification of claim (2) wherein said virtual assets are limited to those virtual assets that may be used in trade for or as a resource, upgrade or power-up, or key that may be used to unlock some feature or area within the game that would otherwise be unobtainable, or take time and effort to obtain through in-game achievements, or is otherwise scarce and available only in limited supply.

5) The method for behavior modification of claim (2) wherein said virtual assets enable the participant to achieve one or more game objectives more easily or in less time.

6) The method for behavior modification of claim (2) wherein the participant takes on the role of a character in the game.

7) The method for behavior modification of claim (5) wherein the character the participant takes on the role of is portrayed as attempting the same behavioral change that the embodiment of the invention is designed to effect in the participant, and the character's success at making the behavioral change is linked to and dependent upon the participant's actual success at achieving the behavioral change, as assessed in the monitoring procedure.

8) The method for behavior modification of claim (1) wherein said interactive digital environment is a virtual world.

9) The method for behavior modification of claim (5) wherein said virtual assets are limited to those virtual assets that have intrinsic value to the participant but no programmed utility, functionality or impact on the virtual world when deployed within the virtual world.

10) The method for behavior modification of claim (5) wherein said virtual assets are limited to those virtual assets that may be used in trade for or as a resource, upgrade or power-up, or key that may be used to unlock some feature or area within the virtual world, that would otherwise be unobtainable, or take time and effort to obtain through in-world achievements, or is otherwise scarce and available only in limited supply.

11) The method for behavior modification of claim (1) wherein said interactive digital environment is a simulation.

12) The method for behavior modification of claim (8) wherein said virtual assets are limited to those virtual assets that have intrinsic value to the participant but no programmed utility, functionality or impact on the game when deployed within the simulation.

13) The method for behavior modification of claim (8) wherein said virtual assets are limited to those virtual assets that may be used in trade for or as a resource, upgrade or power-up, or key that may be used to unlock some feature or area within the simulation that would otherwise be unobtainable, or take time and effort to obtain through in-simulation achievements, or is otherwise scarce and available only in limited supply.

14) The method for behavior modification of claim (1) wherein incentive rewards are limited to prompted social reinforcement.

15) The method for behavior modification of claim (1) wherein incentive rewards are limited to virtual assets.
